(19) United States
(12) Patent Application Publication
(10) Pub. No.: US 2016/0283988 A1
(43) Pub. Date: Sep. 29, 2016

(54) Processing System and Method to Facilitate Sponsored Fund Raising

(71) Applicant: Fred W. Layman, III, Grovetown, GA (US)

(72) Inventor: Fred W. Layman, III, Grovetown, GA (US)

(21) Appl. No.: 14/666,045

(22) Filed: Mar. 23, 2015

(51) Int. Cl. G06Q 30/02; G06Q 50/00

(52) U.S. Cl. CPC G06Q 30/0279; G06Q 30/0213; G06Q 50/01

(57) ABSTRACT

This invention teaches a processing system and business method for incentivizing and inducing predominantly mobile online customers as members of a service provider club via paid subscription, to donate in support of causes to for-profit business fundraisers or non-profit organization fundraisers of one's choice and selection while redeeming offers of discounted deals on purchases offered by participating merchants on products or services, while said club provides and maintains all activities incidental to said method, for fee or commission without further obligations while, in addition, said merchant may also donate to said fundraiser. To fundraisers, the system and method alleviates solicitation anxiety making the process impersonal yet personalized, social and democratic on a grand or global scale. To merchants, the system and method offers high power novel advertising channels and means. To customers, the system and method offers private time, no-pressure, review of causes to learn and understand and a quick-and-easy means (click) to support chosen causes and automatically express opinions on social media, while consuming products and/or services desired by said customers.

### FIELD OF THE INVENTION

This invention relates generally to systems and methods of generating funds for charitable organizations or charitable causes and for other service-based groups such as firefighters, policemen, soldiers and teachers. More particularly, the present invention relates to a subscription-based online fund raising system and method for such organizations or causes on behalf of fundraisers (essentially community organizations), wherein subscribing donors are rewarded by receiving discounts on products and services promoted by businesses and then selected by donors as the beneficiaries of the promotions supported by the fundraisers, wherein part of the subscription and/or the donation is withheld by the online service provider for its services.

This invention teaches a primary purpose of encouraging and facilitating merchant-sponsored fundraising by use of mobile or other online devices (such as iPhones, iPads, Android tablets, Windows Phones, internet accessible computers, etc.) and smart cards, thereby addressing a pressing need for ease and fluidity of such transactions.

### BACKGROUND OF THE INVENTION

Many attempts at fundraising on the internet have occurred and even more attempts have been made by offering discounts for merchandise and services online. None of these attempts have proposed to combine the interests of such activities by providing a secure platform and system to accomplish these desired activities for the benefit of all parties involved.

Current systems assume such functions only in part and are predominantly fragmented. Inefficiency is an inevitable consequence. Bulk targeting is difficult. The level of integration is low. The scope and extent of related information collection and dissemination is narrow and limited. The current state-of-the-art simply leaves fundraising separated from shopping.

### SUMMARY OF THE INVENTION

For a nominal fee or commission, a service provider can be dedicated to attend to such functions, tracking all relevant information and channeling funds and information to the parties as desired. Such a service provider may offer bookkeeping of transactions and reporting to taxing authorities on behalf of the fundraiser, the merchant and the consumer. Merchants can also use the system to advertise their products and/or services in a way that is directly customized to consumer's preference profile, as that may change over time.

Therefore, one of the primary objects of the present invention is to remedy these weaknesses and provide an efficient and secure system and method to achieve the above stated goals.

The above problems and others are at least partially solved and the above objects realized in a process and method, which according to the teachings of this invention, uses at least one application for mobile phones or computing devices, which also may be accessed via the internet by computers, performing at least the following service provider functions:
1. Signing up, for a yearly renewable fee, consumers to become members of a club as participating customers;
2. Informing said members about the cause and activities of participating fundraisers;
3. Transferring an agreed upon portion of said annual fee to at least one fundraiser of the choice of said members through number code recognition;
4. Posting and managing merchant coupons, discount offers and related advertisements;
5. Guiding customers (consumers) to a merchant website and/or physical location;
6. Collecting donations from said customers (consumers) on behalf of said fundraisers upon consecutive and repeated purchases and coupon redemptions;
7. Retaining part of said donations for defraying cost of services provided and transferring the rest to the customer (consumer) selected fundraiser;
8. Manage related information flow;
9. Offer related tracking and accounting services;
10. Offer related tax reporting services;
11. Offer choices for customers (consumers), merchants and fundraisers; and
12. Offer grouping of fundraisers and merchants.

### BRIEF DESCRIPTION OF THE DRAWINGS

Referring to the drawings:

FIG. 1 is a money flow diagram of an exemplary method as per the teachings of the invention, representing minimal connectedness.

FIG. 2 is a money flow diagram of another exemplary method of the present invention, allowing for direct donations.

FIG. 3 is a money flow diagram of yet another exemplary method of the present invention, allowing for direct donations and commissions.

FIG. 4 is a money flow diagram of yet another exemplary method of the present invention, allowing merchant donations.

FIG. 5 is a money flow diagram of yet another exemplary method of the present invention, allowing merchant matching donations and direct payments to a service provider.

FIG. 6 is a money flow diagram of yet another exemplary method of the present invention, allowing customer and merchant donations to be channeled through the service provider.

FIG. 7 is a diagrammatic assembly view illustrating the system components required to provide the related services as per the teachings of the invention.

### DETAILED DESCRIPTION OF A PREFERRED EMBODIMENT

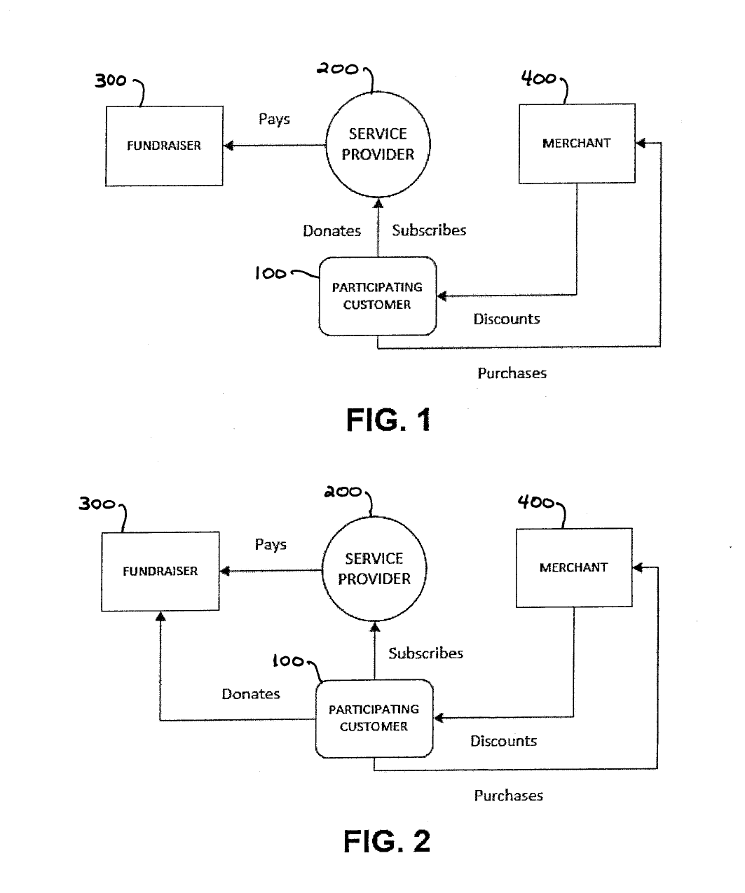

Attention is now turned to FIG. 1, which illustrates a money flow diagram of an exemplary method as per the teachings of the invention, representing minimal connectedness, illustrating the monetary relationship between a PARTICIPATING CUSTOMER 100, hereinafter CUSTOMER 100, a SERVICE PROVIDER 200, hereinafter PROVIDER 200, a FUNDRAISER 300 and a MERCHANT 400, where arrows point to the direction of money flow.

Here, and throughout FIG. 6, the money source is said CUSTOMER 100 and the money sink is said FUNDRAISER 300. The MERCHANT 400 and the PROVIDER 200 are passing or backflow agents, but in part are also sinks.

An exemplary operation of the present invention may work as follows:
1. PROVIDER 200 advertises its services via digital mobile/online application;
2. CUSTOMER 100 downloads the online application subscribing to PROVIDER 200 (say as a club member) for a yearly fee (if subscribed already, CUSTOMER 100 may renew automatically or manually at CUSTOMER's 100 discretion);
3. CUSTOMER 100 selects a cause to support and a FUNDRAISER 300 to donate to (CUSTOMER 100 may pick one or more FUNDRAISERs 300 to donate to and may request the distribution of the donation selectively;
4. PROVIDER 200 passes a portion (say 50-95%) of the annual subscription fee paid by CUSTOMER 100 to FUNDRAISER 300;
5. MERCHANT 400 advertises its services or products at PROVIDER's 200 online portal and offers coupons and/or discounts (deals) to CUSTOMER 100 on one or more of said services or products;
6. CUSTOMER 100 picks a deal (say by distance, brand, price or such);
7. PROVIDER 200 guides CUSTOMER 100 to MERCHANT's 400 physical location (say by satellite navigation);
8. CUSTOMER 100 identifies himself (say by picture or fingerprint) and consumes and redeems his deal upon which he offers to donate to FUNDRAISER 300 (say at least $1.00) as he agreed upon at sign-up;
9. PROVIDER 200 passes a pre-agreed-upon portion of the donation to FUNDRAISER 300 (say 90%);
10. PROVIDER 200 sends “Thank you” message to CUSTOMER 100 on behalf of FUNDRAISER 300 and offers opportunity for more donations and more deals (for CUSTOMERs 100 not having modern mobile electronics, PROVIDER 200 may issue cards having quick response codes [QR codes] to facilitate redemption);
11. PROVIDER 200 keeps track of all transactions and informs CUSTOMER 100, MERCHANT 400 and FUNDRAISER 300 by line items and statistics;
12. PROVIDER 200 offers bookkeeping on transactions and reporting to taxing agencies and commercial authorities on behalf of CUSTOMER 100, MERCHANT 400 or FUNDRAISER 300 as per their request, if wanted and agreed upon beforehand;
13. PROVIDER 200 offers sharing of contact information of CUSTOMER 100, MERCHANT 400 or FUNDRAISER 300 upon prior consent of the parties;
14. PROVIDER 200 offers flexibility of rules regulations and agreements between CUSTOMER 100, MERCHANT 400 and/or FUNDRAISER 300 subject to change in time and space;
15. MERCHANT 400 is given an opportunity to advertise non-discounted items at PROVIDER 200 website;
16. FUNDRAISER 300 may delineate the cause[s] for raising funds and may explain how funds will be spent.

An example of the system and method of the present invention would be that CUSTOMER 100 activates or renews his subscription to PROVIDER 200 by paying a $40 annual fee. PROVIDER 200 would pass $20 of said annual fee to FUNDRAISER 300. Then, say once a month, CUSTOMER 100 consumes a meal in a MERCHANT 400 establishment for $24 discounted to $20. Upon each redemption CUSTOMER 100 donates $1.00 to FUNDRAISER 300, out of which PROVIDER 200 retains $0.10 and pays to FUNDRAISER $0.90.

Thus, FUNDRAISER 300 would receive in that year from this CUSTOMER $30.80. CUSTOMER 100 would consume $240 and save $36 via MERCHANT 400 discounts. However, CUSTOMER 100 may consume more meals in a year and buy more merchandise from this MERCHANT 400 or from other MERCHANTS 400 in this club. Here, MERCHANT 400 forgoes $48 on this CUSTOMER 100 on a $288 annual purchase, netting $240 only. The $48 discount provided by MERCHANT 400 however would be considered well spent, since without it, this CUSTOMER 100 may not have chosen this MERCHANT 400 or have come in to MERCHANT's 400 establishment in the first place. Thus MERCHANT 400 would consider this to be an acceptable advertisement expense. PROVIDER's 200 revenue from this transaction would be $21.20, which equals 68.8% of the raised funds and 8.8% of the net consumption.

The process and method of the present invention removes the anxiety of fundraising and rewards the donor by lucrative deals on purchases planned regardless of the donation aspect of the transaction. Some variations of the process of the present invention are in order. Labels will be retained, for brevity only, and the modifications will be explained.

Attention is now turned to FIG. 2, which illustrates a money flow diagram of another exemplary process and method of the present invention, which is the same as the one shown in FIG. 1, but now allowing CUSTOMER 100 to donate directly to FUNDRAISER 300.

While part of the CUSTOMER's 100 annual subscription fee is shown to be shared between the PROVIDER 200 and the FUNDRAISER 300 here, CUSTOMER 100 here is allowed to donate directly to FUNDRAISER 300, in which case, PROVIDER 200 does not retain a portion of the donation. That alone, would justify PROVIDER 200 not sharing CUSTOMER 100 subscription or renewal fee with FUNDRAISER 300 (not shown). However, just as shown here, PROVIDER 200 may choose to do that anyway, while additionally, CUSTOMER 100 may pay, that is donate, a portion of his donation to PROVIDER 200 (not marked). In such case, even the subscription fee can be made free by accepting the suggested donation instead to PROVIDER 200 as well. In this case, a CUSTOMER 100 may not receive a full and customized service, but a basic one, which can be given away at the expense of donating CUSTOMERs 100.

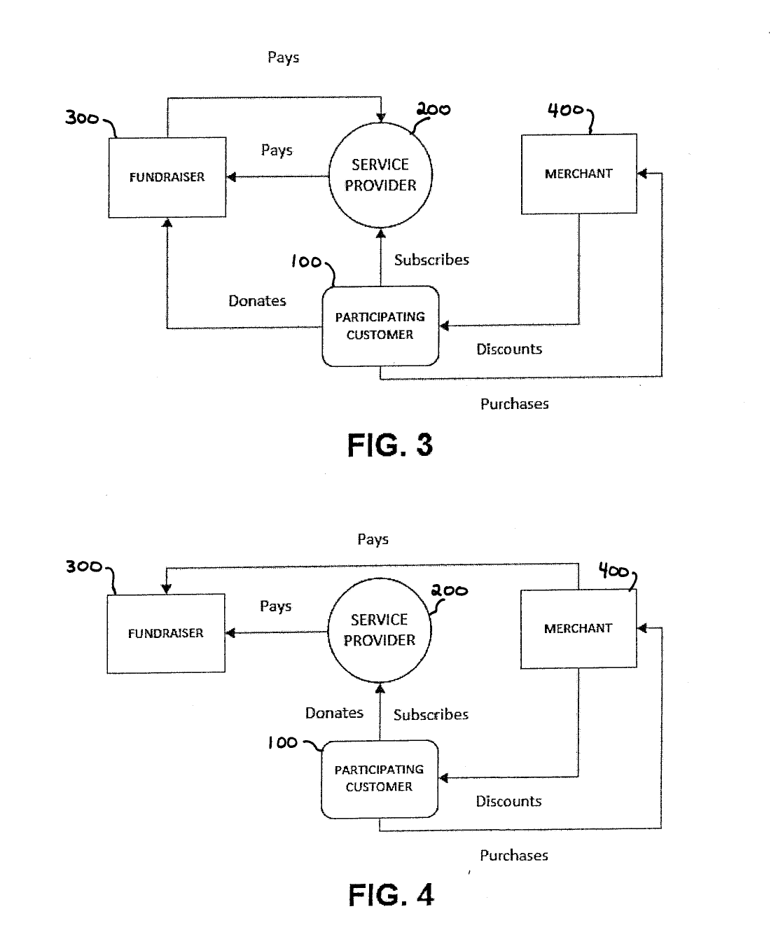

Attention is now turned to FIG. 3, which illustrates a money flow diagram of yet another exemplary process and method of the present invention, allowing for direct donations by CUSTOMER 100 to FUNDRAISER 300 and commissions from FUNDRAISER 300 to PROVIDER 200.

Here all that is disclosed for FIG. 2 holds, plus that now FUNDRAISER 300 pays a commission or fundraising fee to PROVIDER 200. This may be done to compensate PROVIDER 200 for lost revenues due to direct donations. While payment by FUNDRAISER 300 to PROVIDER 200 may also be considered a donation, for tax purposes, one may have to classify the payment as service fee. A much different configuration is discussed next.

Attention is now turned to FIG. 4, which illustrates a money flow diagram of yet another exemplary process and method of the present invention, allowing direct donations by MERCHANT 400 to FUNDRAISER 300, while channeling CUSTOMER 100 donations to FUNDRAISER 300 through PROVIDER 200.

This case is the same as the one illustrated in FIG. 1, however with supplemental donations by MERCHANT 400 to FUNDRAISER 300, for instance, CUSTOMER 100 donations matched by MERCHANT 400 donations in 1:1 or any other agreed upon ratio.

An example of the process shown in FIG. 4 would be that CUSTOMER 100 subscribes or renews his subscription to PROVIDER 200 by paying a $40 annual fee. PROVIDER 200 would pass $20 of the annual subscription fee to FUNDRAISER 300. Then, say once a month, CUSTOMER 100 consumes a meal in a MERCHANT 400 establishment for $24 discounted to $20. Upon redemption, CUSTOMER 100 donates $1.00 to FUNDRAISER 300, out of which, PROVIDER 200 retains $0.10 and pays to FUNDRAISER 300 $0.90. MERCHANT 400 now matches CUSTOMER's 100 donation by donating $1.00 directly to FUNDRAISER 300.

Thus, FUNDRAISER 300 would receive in that year from this CUSTOMER 100 $42.80. CUSTOMER 100 would consume $240 and save $36 via MERCHANT 400 discounts. However, CUSTOMER 100 may consume more meals in a year and buy more merchandise from this MERCHANT 400 or from others in this club. Here, MERCHANT 400 forgoes $48 on this CUSTOMER 100 on a $288 purchase, netting $240 only. The $48 discount provided by MERCHANT 400, split as $12 for FUNDRAISER 300 and $36 for CUSTOMER 100, however would be considered well spent, since without it this CUSTOMER 100 may not return or may not have come in to the MERCHANT's 400 establishment in the first place. Thus MERCHANT 400 would consider this to be an acceptable advertisement expense. The PROVIDER's 200 revenue from this transaction would be $21.20, which equals 49.5% of the raised funds and 8.8% of the net consumption.

Comparing this case to the one depicted in FIG. 1 demonstrates that PROVIDER 200 and MERCHANT 400 are unaffected, yet FUNDRAISER 300 boosted its raised funds by 39% as a result of its participation in this process. For that, in exchange, FUNDRAISER 300 would be incentivized to assist in promoting MERCHANT's 400 offerings and MERCHANT 400 would gain even more customers as a result. For this gain, MERCHANT 400 would be incentivized to pay PROVIDER 200 to further facilitate this cycle. An example of this is illustrated next.

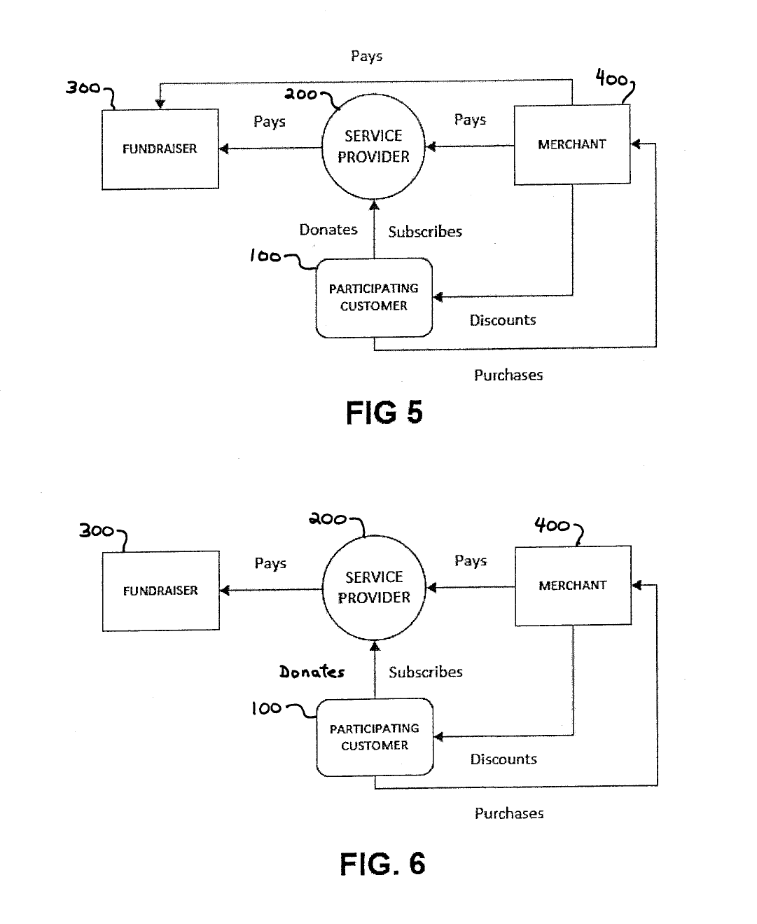

Attention is now turned to FIG. 5, which illustrates a money flow diagram of yet another exemplary method, allowing donations by MERCHANT 400 to FUNDRAISER 300 and PROVIDER 200 by payment flowing from MERCHANT 300 to PROVIDER 200. This is an expansion of the method illustrated in FIG. 4, however with different revenue distribution.

An example of the process shown in FIG. 5 would be that CUSTOMER 100 subscribes or renews his subscription to PROVIDER 200 by paying a $40 annual fee. PROVIDER 200 would pass $20 of the annual subscription fee to FUNDRAISER 300. Then, say once a month CUSTOMER 100 consumes a meal in a MERCHANT 400 establishment for $24 discounted to $20. Upon redemption, CUSTOMER 100 donates $1.00 to PROVIDER 200, out of which PROVIDER 200 retains $0.10 and pays to FUNDRAISER 300 $0.90. MERCHANT 400 now matches CUSTOMER's 100 donation by donating $0.50 to PROVIDER 200 and $0.50 to FUNDRAISER 300. PROVIDER 200 then passes $0.45 of it's donation from MERCHANT 400 to FUNDRAISER 300 and retains $0.05 for its services.

Thus, FUNDRAISER 300 in this example would receive in that year from this CUSTOMER 100 $36.20. CUSTOMER 100 would consume $240 and save $36 via MERCHANT 400 discounts. However, CUSTOMER 100 may consume more meals in a year and buy more merchandise from this MERCHANT 400 or from other MERCHANTs 400 in this club. Here MERCHANT 400 forgoes $48 on this CUSTOMER 100 on a $288 purchase, netting $240 only. The $48 discount provided by MERCHANT 400, split as $6 for PROVIDER 200, $6 for FUNDRAISER 300 and $36 for CUSTOMER 100, however would be considered well spent, since without it this CUSTOMER 100 may not return or may not have come in to MERCHANT's 400 establishment the first place. Thus MERCHANT 400 would consider this to be an acceptable advertisement expense. The PROVIDER's 200 annual revenue from this transaction would be $21.8, which equals 60.2% of the raised funds and 9.1% of the net consumption.

The FUNDRAISER 300 in this example hardly suffers, still boosting its received funds by 17.5% compared to the case shown in FIG. 1 and thus would be greatly incentivized to assist PROMOTER 200 in promoting MERCHANT's 400 offerings. MERCHANT 400 thus increases its potential to receive more business in this modified cycle.

It should be obvious now that it can be even more beneficial to channel both CUSTOMER 100 and MERCHANT 400 donations to FUNDRAISER 300 through PROVIDER 200, as the most practical way to organize this chain of commerce, in which a CUSTOMER 100 expresses his preference for an offered product or service and his desire for donating to a cause by purchasing and donating at the same time automatically. Such a method configuration is illustrated next.

Attention is now turned to FIG. 6, which illustrates a money flow diagram of yet another exemplary method, which has two sources of donation, namely CUSTOMER 100 and MERCHANT 400, while all of their donations are channeled through PROVIDER 200. An example of the process shown in FIG. 6 would be that CUSTOMER 100 subscribes or renews his subscription to PROVIDER 200 by paying a $40 annual fee. PROVIDER 200 would pass $20 of that to FUNDRAISER 300. Then, say once a month, CUSTOMER 100 consumes a meal in a MERCHANT 400 establishment for $24 discounted to $20. Upon redemption, CUSTOMER 100 donates $1.00 to PROVIDER 200, out of which, PROVIDER 200 retains $0.10 and pays to FUNDRAISER 300 $0.90. MERCHANT 400 now matches CUSTOMER's 100 donation by also donating $1.00 to PROVIDER 200. PROVIDER 200 then passes $0.90 of its donation from MERCHANT 400 to FUNDRAISER 300 and retains $0.10 for its services.

Thus, FUNDRAISER 300 in this example would receive in that year from this CUSTOMER 100 $41.60. CUSTOMER 100 would consume $240 and save $36 via MERCHANT 400 discounts. However, CUSTOMER 100 may consume more meals in a year and buy more merchandise from this MERCHANT 400 or from other MERCHANTs 400 in this club. Here, MERCHANT 400 forgoes $48 on this CUSTOMER 100 on a $288 purchase, netting $240 only. The $48 discount provided by MERCHANT 400, split as $12 for PROVIDER 200 and $36 for CUSTOMER 100, however would be considered well spent, since without it this CUSTOMER 100 may not return or may not have come in to MERCHANT's 400 establishment in the first place. Thus MERCHANT 400 would consider this to be an acceptable advertisement expense. The PROVIDER's 200 annual revenue from this transaction would be $22.40, which equals 53.8% of the raised funds and 9.3% of the net consumption.

Comparing this to the previous case, one may see that the revenues are hardly different now, but all parties in this chain have more incentive and a better controlled means to promote member MERCHANT's 400 offerings and automatically make donations to chosen causes. In this case, FUNDRAISER 300 boosted his raised fund by 35.1% compared to the basic case illustrated in FIG. 1.

To the skilled in the art, it shall be obvious by now that further combinations of the above presented process and methods are also valid and practical. For instance, one may add direct CUSTOMER 100 donations to FUNDRAISER 300 into FIG. 5 the same way as shown in FIGS. 2 and 3 above. The distribution of money sources and sinks in the stated scenarios would vary, except for PROVIDER 200, which always remains a sink for providing its services. Nevertheless, one may configure a method in which PROVICER 200 would also donate to FUNDRAISER 300, however accountants and tax authorities could call that financing inventive, rather than regular.

Note that in scenarios where the MERCHANT 400 donates the matching $1.00 directly to FUNDRAISER 300, the CUSTOMER 100 is more incentivized to donate his $1.00 for seeing his effort doubled. While the CUSTOMER 100 would get the same $4.00 discount, the $24 price discounted to $20, the CUSTOMER 100 by no means feels that he received only a $3.00 discount, but rather as if he would have donated $2.00 instead of $1.00 by leveraging his $1.00 with the MERCHANT's 400 money. CUSTOMER 100 may feel this just and can be more supportive up to the point of over consuming.

Note also that multiple CUSTOMERs 100 consume ordinarily more in any given year and donate to either a single FUNDRAISER 300 or to multiple ones, while PROVIDER 200 facilitates CUSTOMER 100 choices both in MERCHANT 400 and FUNDRAISER 300 selections. As such, this would modify the above gains and percentages to more lifelike ranges. For instance, a CUSTOMER 100 consuming 10 times more in the last case would raise $216 in donated funds at a cost of $44 for the services provided by PROVIDER 200, which equals approximately 20% of funds raised and 2% of net consumption.

Furthermore, the exemplary annual subscription or renewal fee of $20 to FUNDRAISER 300 does not go to any single fundraiser but rather half of all CUSTOMER's 100 annual subscription fees is distributed between numerous fundraisers, so its value, compared to the value of the continuous customer donations is diminishing. Had PROVIDER 200 retained all the annual subscription fees, FUNDRAISERs 300 may not even notice. Yet, for the same reason as previously explained in the matching fund incentive above, CUSTOMERs 100 would be incentivized and could sign up with more ease by knowing that half of their yearly fee goes to support their favorite charity.

FUNDRAISER 300 can be any person, group or entity, who publishes a cause for which the FUNDRAISER 300 solicits and accept donations and explains the use of the funding collected.

MERCHANT 400 can be any person or entity, who advertises the sale of products and/or services for a fee, price or other product or services if the MERCHANT 400 is willing to accept bartering.

CUSTOMER 100 can be any person or entity who is able to purchase products or services and is able and willing to donate to a cause.

PROVIDER 200 can be any service provider with capability to attend the functions specified above and has the means to serve accordingly.

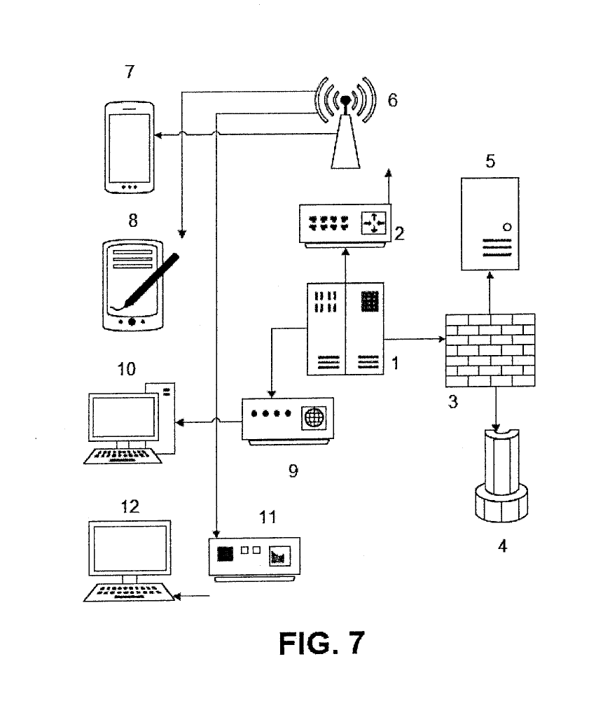

The primary means of access and use of the present invention is through the use of one or more digital applications designed to run on mobile devices and internet accessible computers. For those who have no access to such computing devices, service provider may issue cards with quick response codes [QR codes]. FIG. 7 illustrates the minimum hardware set necessary for access and use of the present invention.

Attention is, therefore now turned to FIG. 7, which by a diagrammatic assembly view illustrates the minimum system components necessary to provide access and use of the process and method of the present invention.

The assembly of FIG. 7 comprises a main server 1, a hub or router 2, a firewall 3, a mainframe storage or cloud 4, one or more servers 5, a wireless spot 6, smartphones 7, tablets 8, modems 9, PCs 10, bridges or switches 11 and terminals 12.

Features and capabilities in accordance with the teachings of the present invention specific to said processing system and methods may include some or all of the following online application actions:
1. Immediately upon purchase by customer, fundraiser, service provider and other individuals or entities involved in said transaction receives a receipt via email transmission
2. Fundraiser gets name and address for data base and contribution tax filing
3. Upon redemption, customer receives email “Thank you” from service provider, merchant and fundraiser all in one transmission
4. Adjustment of percentage paid to fundraiser and extra donation(s)
5. Proprietary site for fundraiser to check sales
6. Management of back end reporting, offers, merchants, territories, sales, redemptions, customers, fundraisers
7. Extra donation feature in $1.00 increments
8. After redemption donation (plus 1, 2, 3, . . . N)
9. With registration number code, fundraiser has the ability to earmark after redemption donation(s) and extra donation to exact activities
10. Customer geographic location locates the closest merchant in all categories to customer's current location
11. Merchant search by city, search by mile, search by zip code
12. Fundraiser search by fundraiser name, salesman name and by city
13. Scrolling banner ads for merchants option
14. Merchants can place multiple offers and can change ads in real time
15. Secure redemption process with member picture and running clock
16. Branding of fundraiser on redemption capability
17. Customer card redemption validation with QR code scan
18. Refer a friend capability
19. Gift an application for fundraiser
20. Printable merchants search results from website
21. Ability to track individual sales, group sales, entire fundraiser events, teams or just schools through registration number code recognition
22. Automatic renewal feature
23. Push notification and email notification for every new merchant offer and events
24. Push notification or email notification for merchant events and upgrades on offers
25. Customize pricing model based on email address and domain names
26. Retrieving offer categories according to the zip code and miles specified by customer
27. Built-in merchant application for IOS, separate for android, system is recognizing the merchant and user automatically with username and password entered
28. Card and batch-card printing technology from the service provider
29. Recurring payment collection from the processing system
30. Deactivate recurring payment from service provider on customer's request
31. Custom banner advertisements capability
32. Merchant website and phone number hot links
33. Send an application feature on website
34. Track up to three activities per individual sale and disseminate monies equally
35. Refer a friend and gifting gets a bonus capability
36. Business merchant portal maintenance
37. Send separate coupon three or four days after redemption
38. Merchant search capability
39. Driving directions to merchant location
40. Geo-fencing of merchant location if one drives by said location
41. Send email of redemption to business merchant
42. Ability to feature a merchant
43. Fundraiser detail management page
44. Offer of push or email notification history within the application process
45. Donation recognition “With Gratitude” page on application and website for extra donation
46. Donation recognition “With Gratitude” banner ad capability
47. Option to change payment method
48. Option to display fundraiser logo and mission statement
49. Option to have a global, chain, or internet merchant that does not rely on specific geographic location(s)
50. Detailed sales and revenue distribution report capability
51. Customer profile settings that allows for adjustment of preferences
52. Extra donation push notification to fundraiser donors and system customers
53. Matching donor capability
54. Receipting
55. Fundraiser creation service
56. Multiple charity with directed donation
57. Upon redemption, sharing of one's discount via Facebook
58. Fundraiser access to contacts
59. Pre-population of member customer registration code
60. National fundraising companies partnering
61. Notifications (selective and targeted)
62. Navigation link
63. Plus one donation feature appears after redemption
64. Hot link to fundraiser's website from redemption
65. Tallied savings and donations
66. Exit donation
67. Merchant QR or Bar Code
68. Facial recognition customer ID
69. Fingerprint identifier
70. Auto IRS connect or report
71. Selective features opt-in and opt-out
72. Speech recognition
73. Fundraiser and campaign branding
74. Google and Apple compatibility

The software application capability list shown here is not exhaustive, nor is the exemplary system hardware grouping shown in FIG. 7.

The present invention is described above with reference to a preferred embodiment. However, those skilled in the art will recognize that changes and modifications may be made in the described embodiment without departing from the nature and scope of the present invention. For instance, configuring the process and method as to all participants, i.e. CUSTOMER 100, MERCHANT 400, FUNDRAISER 300 and PROVIDER 200, as to who would be sink and source in the money flowchart, is hereby considered intuitive and thereby obviously instructive over the teachings of this invention. Adding more software application solutions to perceived need to enhance features is also considered within the scope of the invention.

Various further changes and modifications to the embodiment herein chosen for purposes of illustration will readily occur to those skilled in the art. To the extent that such modifications and variations do not depart from the spirit of the invention, they are intended to be included within the scope hereof.

Having fully described the invention in such clear and concise terms as to enable those skilled in the art to understand and practice same, the invention claimed is:

1. A processing system and method for incentivizing and inducing predominantly mobile online customers as members of a service provider club by paid subscription to donate in support of at least one cause to at least one participating fundraiser of one's choice and selection while redeeming offers of at least one discounted deal on purchases offered by at least one participating merchant on its products and/or services while said club provides and maintains any necessary activities incidental to said method for fee or commission, said system and method comprising the steps, performed by a processor, of:
(a) assigning a unique number code to each participating fundraiser;
(b) signing up customers within said system to become participating members of said club by paying a subscription fee;
(c) informing said members of the causes and activities of said participating fundraisers using fundraiser's unique number code;
(d) transferring an agreed upon portion of said subscription fee to at least one fundraiser chosen by said member;
(e) posting and managing merchant offered deal discounts and related advertisements;
(f) guiding said members to merchant websites and/or merchant physical locations;
(g) collecting donations from said members on behalf of said fundraisers from consecutive and repeated purchases and redemptions of merchant deals;
(h) retaining part of said donations to defray system costs;
(i) transferring net donations to selected fundraisers;
(j) managing information flow;
(k) offering transaction tracking and accounting services to all parties;
(l) offering tax reporting services to all parties;
(m) offering choices to members, merchants and fundraisers; and,
(n) offering groupings of fundraiser and merchants.

2. The system and method of claim 1, wherein said fundraiser is a for-profit business.

3. The system and method of claim 1, wherein said fundraiser is a non-profit organization.

4. The system and method of claim 1, wherein said donations support a multiplicity of said fundraisers.

5. The system and method of claim 1, wherein said purchases are for a multiplicity of said deals.

6. The system and method of claim 1, wherein said deals are offered by a multiplicity of said merchants.

7. The system and method of claim 1, wherein said subscription fee is paid by said customer directly to said club.

8. The system and method of claim 1, wherein said fee or commission to said club is paid by said merchant.

9. The system and method of claim 8, wherein said club passes a portion of said fee or commission to said fundraiser.

10. The system and method of claim 8, wherein said fee or commission is paid by said fundraiser.

11. The system and method of claim 1, wherein said donation is direct from said member customer to said fundraiser.

12. The system and method of claim 1, wherein said donation from said member customer to said fundraiser is channeled through said club, which retains a portion of said donation.

13. The system and method of claim 1, wherein said merchant also makes a donation to said fundraiser.

14. The system and method of claim 13, wherein said donation by said merchant is paid directly to said fundraiser.

15. The system and method of claim 13, wherein said donation by said merchant is channeled through said club, which retains a portion of said donation.

16. An apparatus for incentivizing and inducing predominantly mobile online customers as members of a service provider club by paid subscription to donate in support of at least one cause to at least one participating fundraiser of one's choice and selection while redeeming offers of at least one discounted deal on purchases offered by at least one participating merchant on its products and/or services while said club provides and maintains any necessary activities incidental to said method for fee or commission, said apparatus comprising:
(a) means for assigning a unique number code to each participating fundraiser;
(b) means for signing up customers within said system to become participating members of said club by paying a subscription fee;
(c) means for informing said members of the causes and activities of said fundraisers;
(d) means for transferring an agreed upon portion of said subscription fee to at least one fundraiser chosen by said member;
(e) means for posting and managing merchant discounts on offered deals and related advertisements;
(f) means for guiding said members to merchant websites and/or merchant physical locations;
(g) means for collecting donations from said members on behalf of said fundraisers upon consecutive and repeated purchases and redemptions of merchant deals;
(h) means for retaining part of said donations to defray system costs;
(i) means for transferring net donations to selected fundraisers;
(j) means for managing information flow;
(k) means for offering transaction tracking and accounting services to all parties;
(l) means for offering tax reporting services to all parties;
(m) means for offering choices to members, merchants and fundraisers; and,
(n) means for offering groupings of fundraiser and merchants.

17. The apparatus of claim 16, further comprising a processor means for performing the objects and activities associated with said apparatus.

18. The system and method of claim 1, wherein said activities necessary and incidental to said method provided and maintained by said club comprise at least one of the following predominantly mobile online processes:
a. Immediately upon purchase of discounted deal by member customer, fundraiser, service provider club and other individuals or entities involved in said transaction receive a receipt via email transmission;
b. Fundraiser gets name and address for data base and contribution tax filing;
c. Upon redemption, member customer receives email “Thank you” from service provider club, merchant, fundraiser all in one transmission;
d. Adjustment of percentage paid to fundraiser and any extra donation(s);
e. Proprietary site for fundraiser to check sales;
f. Management of back end reporting, offers, merchants, territories, sales, redemptions, customers, fundraisers;
g. Extra donation feature in $1.00 increments;
h. After redemption donation in $1.00 increments;
i. With unique number code, fundraiser has ability to earmark after redemption donation(s) to exact activities;
j. Member customer geographic location locates the closest merchant in all categories to customer's current location;
k. Merchant search by city, search by mile, and search by zip code;
l. Fundraiser search by fundraiser name, salesman name and by city;
m. Scrolling banner ads for merchants;
n. Option for merchants to place multiple offers and to change ads in real time;
o. Secure redemption process with member picture and running clock;
p. Branding of fundraiser on redemption option;
q. Customer redemption validation with QR code scan;
r. Refer a friend option;
s. Gift an application option;
t. Printable merchants search results from website;
u. Ability to track individual sales, group sales, entire fundraiser events, teams or schools through number code recognition;
v. Automatic renewal feature;
w. Push notification and email notification for every new merchant offer and events;
x. Push notification or email notification for merchant events and upgrades on offers;
y. Customize pricing model based on email address domain names;
z. Receiving offer categories according to the zip code and miles specified by member customer;
aa. Built-in merchant application for IOS system, separate for android, is recognizing the merchant and user automatically with username and password entered;
bb. Card and batch-card printing technology from the service provider club;
cc. Recurring payment collection from the processing system;
dd. Deactivate recurring payment from service provider on member customer's request;
ee. Custom banner advertisements option;
ff. Merchant website and phone number hot links;
gg. Send an application feature on website;
hh. Track up to three activities per individual sale and disseminate monies equally;
ii. Refer a friend and gifting gets a bonus capability;
jj. Business merchant portal maintenance;
kk. Send separate coupon three or four days after redemption;
ll. Merchant search capability;
mm. Driving directions to merchant location;
nn. Geo-fencing of merchant location if one drives by said location;
oo. Send email of redemption to business merchant;
pp. Feature a merchant option;
qq. Fundraiser detail management page;
rr. Offer of push or email notification history within the application process;
ss. Donation recognition “With Gratitude” for extra donation(s);
tt. Donation recognition “With Gratitude” banner ad capability;
uu. Option to change payment method;
vv. Optional display fundraiser logo and mission statement;
ww. Option to have a global, chain, or internet merchant that does not rely on specific geographical location(s);
xx. Detailed sales and revenue distribution report capability;
yy. Member customer profile settings that allows for adjustment of preferences;
zz. Extra donation push notification to fundraiser donors and member customers;
aaa. Matching donor option;
bbb. Receipting option;
ccc. Fundraiser creation service;
ddd. Multiple charity with directed donation;
eee. Upon redemption, sharing of one's discount via Facebook or other social media;
fff. Fundraiser access to contacts;
ggg. Pre-population of member registration code and fundraiser number code;
hhh. National fundraising companies partnering;
iii. Notifications (selective and targeted);
jjj. Navigation link;
kkk. Plus one donation feature appears after redemption;
lll. Hot link to fundraiser's website from redemption;
mmm. Tallied savings and donations;
nnn. Exit donation;
ooo. Merchant QR or Bar code;
ppp. Facial recognition member customer ID;
qqq. Fingerprint identifier;
rrr. Auto IRS connect or report;
sss. Selective features opt-in and opt-out;
ttt. Speech recognition;
uuu. Fundraiser and campaign branding;
vvv. Google and Apple compatibility.

19. The system and method of claim 1, wherein said activities necessary and incidental to said method provided and maintained by said club comprise most of the following essentially online processes predominantly in the given sequence:
i. Said club advertises its online application;
ii. Said customer downloads application and subscribes to said club as a member for a renewable yearly fee;
iii. Said member customer selects one or more causes to support and one or more fundraisers to donate to and requests the distribution of his donation selectively;
iv. Said club passes a portion of member subscription fee to said fundraiser(s);
v. Said merchant advertises its services or products at a service portal and offers coupons and/or discounted deals on one or more of said deals;
vi. Said customer picks a deal by distance, brand, price or other options;
vii. Said club guides said member customer to said merchant site by online navigation;
viii. Said member customer identifies himself by picture or fingerprint and consumes and redeems his deal upon which he offers to donate to said fundraiser at least $1.00 as he agreed upon at sign-up;
ix. Said club passes a pre-agreed-upon portion of the donation to said fundraiser(s);
x. Said club sends “Thank you” message to said member customer on behalf of said fundraiser and offers chance for more donation(s) and more deals, while for said member customers not having mobile electronics, said club issues cards which provide QR or bar codes to facilitate redemption;
xi. Said club keep track of all transactions and informs said member customer, merchant and fundraiser by line items and statistics;
xii. Said club offers bookkeeping on transactions and reporting to taxing agencies and commercial authorities on behalf of said member customer, merchant and fundraiser as per their request upon prior agreement;
xiii. Said club offers sharing of contact information of said customer, merchant and fundraiser upon prior consent;
xiv. Said club offers flexibility of rules regulations and agreements between said customer, merchant and fundraiser subject to change in time and space;
xv. Said merchants advertise non-discounted items at said club's website;
xvi. Said fundraiser may delineate said cause(s) for raising funds explaining on said club's website how funds will be spent.
